(19) United States
(12) Patent Application Publication
(10) Pub. No.: US 2026/0005899 A1
(43) Pub. Date: Jan. 1, 2026

(54) PERFORMANCE AND COMPLEXITY BASED IMPLEMENTATION OF AI AIDED CHANNEL ESTIMATION

(71) Applicant: Samsung Electronics Co., Ltd., Suwon-si (KR)

(72) Inventors: Mandar Kulkarni, Bridgewater, NJ (US); William Xia, Ozone Park, NY (US); Fan Zhang, Plano, TX (US); Xiaochuan Ma, Hillsborough, NJ (US); Samuel Albert, Robbinsville, NJ (US); Thuy Van Nguyen, Plano, TX (US); Yan Xin, Princeton, NJ (US); Yang Li, Plano, TX (US); Jianzhong Zhang, Dallas, TX (US)

(21) Appl. No.: 19/084,725

(22) Filed: Mar. 19, 2025

Related U.S. Application Data
(60) Provisional application No. 63/665,852, filed on Jun. 28, 2024.

(51) Int. Cl. H04L 25/02; H04W 24/02

(52) U.S. Cl. CPC H04L 25/0242; H04L 25/0256; H04W 24/02

(57) ABSTRACT

A method of channel estimation includes: receiving, at a first electronic device, a signal from a second electronic device on a channel, the received signal modified by a noise, the channel associated with a channel matrix; obtaining a noisy channel based on the received signal and a least squares estimate of the channel matrix; preprocessing the noisy channel to remove at least one of a timing offset, a multiuser interference, or an intercell interference; inputting the preprocessed noisy channel to a CE model trained to perform CE based on the preprocessed noisy channel, the CE model comprising residual learning networks; and estimating the channel matrix based on denoising of the preprocessed noisy channel.

### CROSS-REFERENCE TO RELATED APPLICATION AND CLAIM OF PRIORITY

The present application claims priority under 35 U.S.C. § 119 (e) to U.S. Provisional Patent Application No. 63/665,852 filed on Jun. 28, 2024, which is hereby incorporated by reference in its entirety.

### TECHNICAL FIELD

This disclosure relates generally to wireless communication systems. More specifically, this disclosure relates to apparatuses and methods for artificial intelligence (AI) aided channel estimation in wireless communication systems.

### BACKGROUND

The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance.

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

This disclosure provides AI aided channel estimation methods and apparatuses in wireless communication systems.

In one embodiment, a method of channel estimation is provided. The method includes: receiving, at a first electronic device, a signal from a second electronic device on a channel, the received signal modified by a noise, the channel associated with a channel matrix; obtaining a noisy channel based on the received signal and a least squares estimate of the channel matrix; preprocessing the noisy channel to remove at least one of a timing offset (TO), a multiuser interference (MUI), or an intercell interference (ICI); inputting the preprocessed noisy channel to a CE model trained to perform CE based on the preprocessed noisy channel, the CE model comprising residual learning networks (ResNets); and estimating the channel matrix based on denoising of the preprocessed noisy channel.

In another embodiment, a first electric device includes: a memory and a processor operably coupled to the memory. The processor is configured to: receive a signal from a second electronic device on a channel, the received signal modified by a noise, the channel associated with a channel matrix; obtain a noisy channel based on the received signal and a least squares estimate of the channel matrix; preprocess the noisy channel to remove at least one of a TO, an MUI, or an ICI; input the preprocessed noisy channel to a CE model trained to perform CE based on the preprocessed noisy channel, the CE model comprising ResNets; and estimate the channel matrix based on denoising of the preprocessed noisy channel.

In yet another embodiment, a non-transitory computer readable medium embodying a computer program is provided. The computer program includes program code that, when executed by a processor of a first electronic device, causes the first electronic device to: receive a signal from a second electronic device on a channel, the received signal modified by a noise, the channel associated with a channel matrix; obtain a noisy channel based on the received signal and a least squares estimate of the channel matrix; preprocess the noisy channel to remove at least one of a TO, an MUI, or an ICI; input the preprocessed noisy channel to a CE model trained to perform CE based on the preprocessed noisy channel, the CE model comprising ResNets; and estimate the channel matrix based on denoising of the preprocessed noisy channel.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example wireless network according to embodiments of the present disclosure;

FIG. 2 illustrates an example base station according to embodiments of the present disclosure;

FIG. 3 illustrates an example user equipment according to embodiments of the present disclosure;

FIG. 4 illustrates an example network device according to embodiment of the present disclosure;

FIG. 5 illustrates an example radio access network according to embodiments of the present disclosure;

FIG. 6 illustrates an example time-frequency grid including placement of a sounding reference signal in an uplink slot of an OFDM system according to embodiments of the present disclosure;

FIG. 7 illustrates an example baseline AI channel estimation (CE) model according to embodiments of the present disclosure;

FIG. 8 illustrates an example pipeline of an AI CE method according to embodiments of the present disclosure;

FIG. 9 illustrates an example cyclic shift windowing to remove a multiuser interference from a noisy channel according to embodiments of the present disclosure;

FIG. 10 illustrates an example pipeline for performing adaptive windowing based on soft MMSE weights computation according to embodiments of the present disclosure;

FIG. 11 illustrates an example data offloading method between an AI CE model and a non-AI model according to embodiments of the present disclosure;

FIG. 12 illustrates example noisy channels according to embodiments of the present disclosure;

FIG. 13 illustrates an example cell according to embodiments of the present disclosure;

FIG. 14 illustrates an example sounding devices employed in a cell according to embodiments of the present disclosure;

FIG. 15 illustrates an example model complexity switching method according to embodiments of the present disclosure;

FIG. 16 illustrates an example flow chart of a kernel correlation computation method according to embodiments of the present disclosure;

FIG. 17 illustrates an example low complexity AI CE model according to embodiments of the present disclosure;

FIG. 18 illustrates an example model health monitoring and retraining method according to embodiments of the present disclosure;

FIG. 19 illustrates an example pipeline of an AI CE model utilizing a direct frequency domain input according to embodiments of the present disclosure; and

FIG. 20 illustrates an example flow chart for an AI-aided channel estimation method according to embodiments of the present disclosure.

### DETAILED DESCRIPTION

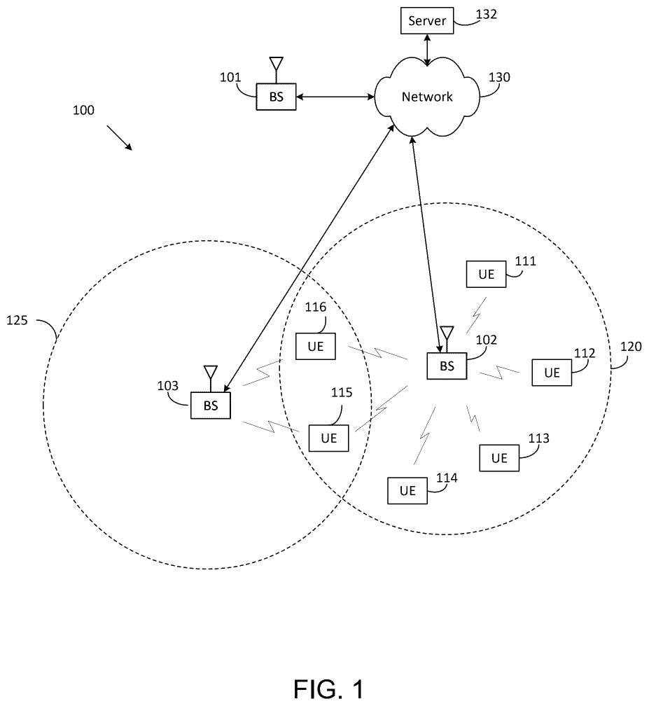

FIGS. 1 through 20, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged wireless communication system.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-4 below describe various embodiments implemented in wireless communications systems and with the use of orthogonal frequency division multiplexing (OFDM) or orthogonal frequency division multiple access (OFDMA) communication techniques. The descriptions of FIGS. 1-4 are not meant to imply physical or architectural limitations to the manner in which different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes a gNB (e.g., base station, BS) 101, a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

The wireless network 100 may be an AI-based cellular system. As such, the at least one network 130 may be operably coupled to a network device (e.g., without limitation, a server) 132 configured to, for example and without limitation, receive data from the gNBs 101-103 via backhaul/network interfaces and train and/or test an AI model to perform channel estimation. The server 132 may represent one or more servers, and each server 132 includes a suitable computing or processing device for training and/or testing the AI model. Each server 132 could, for example, include one or more processing devices, one or more memories storing instructions and data, and one or more network interfaces to receive the data. The AI model can then be trained, tested and deployed to effectively perform channel estimation for reliable and efficient communications in the wireless communication network 100.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, to support the gNB 101-103 for performing wireless communications tasks. In certain embodiments, one or more of the gNBs 101-103 include circuitry, programing, or a combination thereof, to perform wireless communications tasks using the large channel model.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

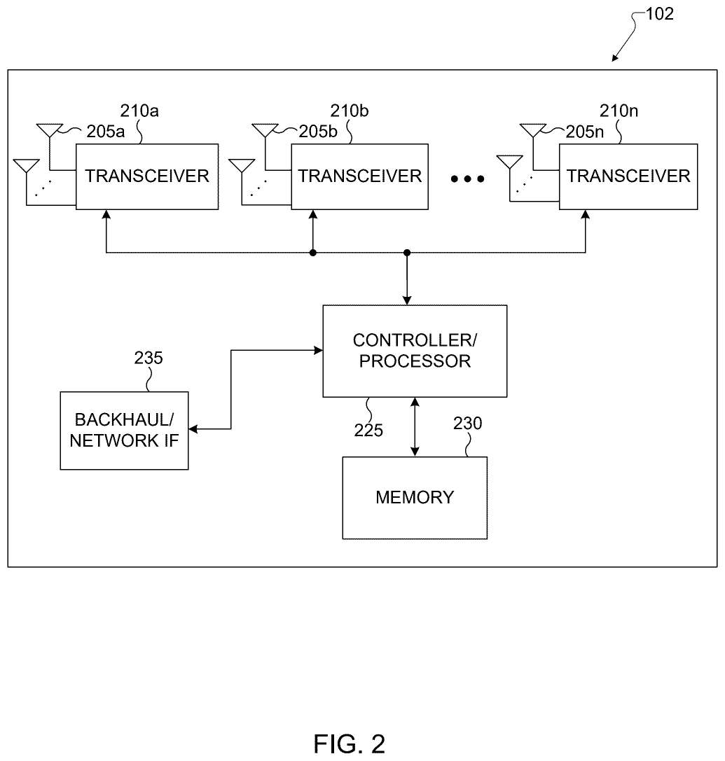

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-convert the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as an OS and, for example, processes to perform AI aided channel estimation as discussed further in detail below. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

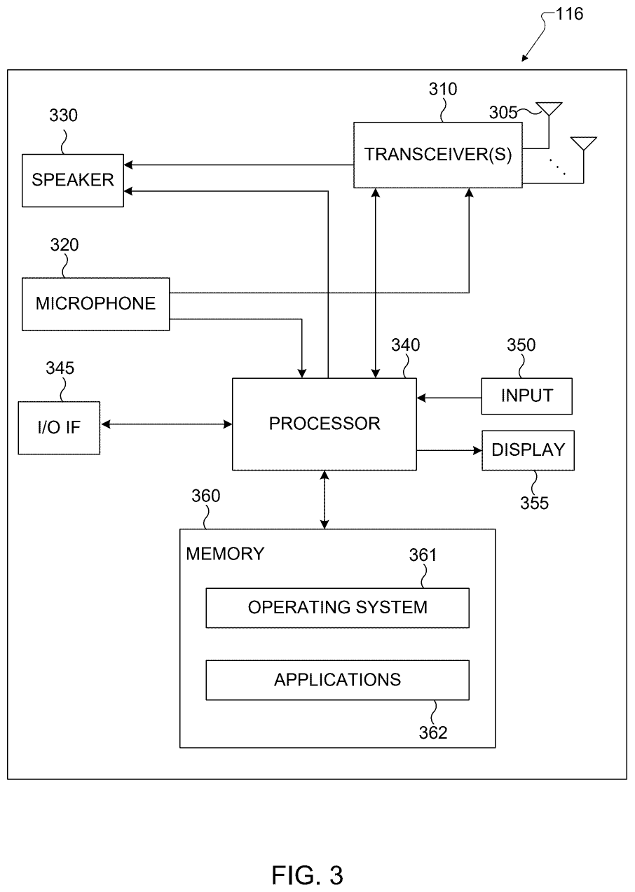

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives, from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, for example, processes to support the AI-aided channel estimation method as discussed in greater detail below. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

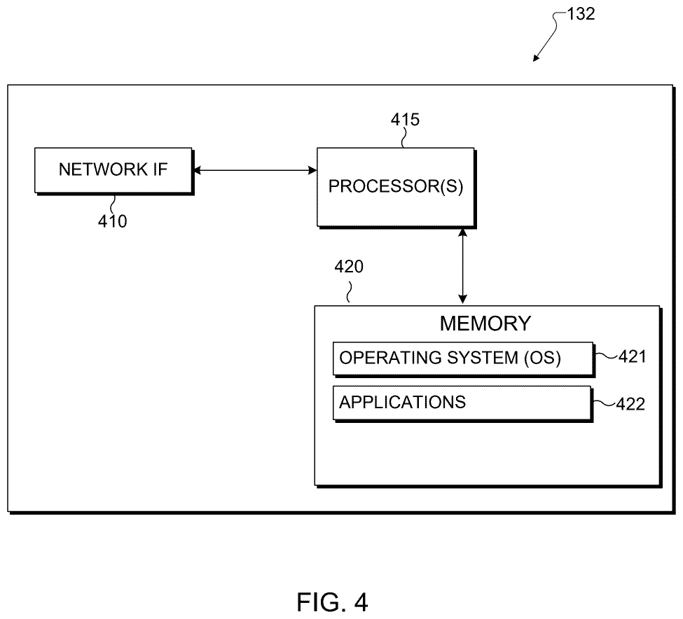

FIG. 4 illustrates an example network server 132 according to embodiments of the present disclosure. The embodiment of the server 132 illustrated in FIG. 4 is for illustration only. Different embodiments of servers 132 could be used without departing from the scope of this disclosure.

The server 132 may be a computing device including at least a network interface 410, a processor 415 and a memory 420. The network interface 410 may support communications over any suitable wired or wireless connection(s). It may include any suitable structure supporting communications over a wired or wireless connection, such as an Ethernet or transceiver. The network interface 410 may be, for example and without limitation, network interface cards (NICs) or network ports. The server 132 may receive data from the gNBs 101-103 via the network interface 410, the UEs 111-116 via the gNBs 101-103, or any other appropriate sources. The server 132 may also train and/or test an AI model to perform channel estimation as discussed further in detail below. The server 132 may then.

The processor 415 is coupled to the network interface 410 and can include one or more processors or other processing devices. The processor 415 can execute instructions that are stored in the memory 420, such as the OS 421 in order to control the overall operation of the server 132. The processor 415 can include any suitable number(s) and type(s) of processors or other devices in any suitable arrangement. For example, in certain embodiments, the processor 415 includes at least one microprocessor or microcontroller. Example types of processor 415 include microprocessors, microcontrollers, digital signal processors, field programmable gate arrays, application specific integrated circuits, and discrete circuitry. In certain embodiments, the processor 415 can include a neural network such as an AI CE model as well as a CPU, a GPU or a tensor processing unit (TPU) that provides significant computational resources required for training the AI CE model.

The processor 415 is also capable of executing other processes and programs resident in the memory 420, such as operations that receive and store data. As described in greater detail below, the processor 415 may execute processes to train and/or test an AI CE model to perform channel estimation in the wireless communication systems. The processor 415 can move data into or out of the memory 420 as required by an executing process. In certain embodiments, the processor 415 is configured to execute the one or more applications 422 based on the OS 421 or in response to signals received from external source(s) or an operator. Example applications 422 can include an AI training application for the AI model.

The memory 420 is coupled to the processor 415. Part of the memory 420 could include a RAM, and another part of the memory 420 could include a Flash memory or other ROM. The memory 420 can include persistent storage (not shown) that represents any structure(s) capable of storing and facilitating retrieval of information (such as data, program code, and/or other suitable information). The memory 420 can contain one or more components or devices supporting longer-term storage of data, such as a read only memory, hard drive, Flash memory, or optical disc.

Although FIG. 4 illustrates one example of the server 132, various changes can be made to FIG. 4. For example, various components in FIG. 4 can be combined, further subdivided, or omitted and additional components can be added according to particular needs. As a particular example, the processor 415 can be divided into multiple processors, such as one or more central processing units (CPUs), one or more graphics processing units (GPUs), one or more neural networks, and the like.

AI has been increasingly integrated in the modern wireless communication such as those described regarding FIGS. 1-4, to enhance performance of critical wireless communication tasks. Recently, native AI algorithms for physical and medium access layer have emerged as candidates to drive the next generation cellular network design. However, such native AI algorithms have yet to be implemented in the commercial wireless communication devices due to numerous engineering problems that need to be solved before such implementation.

For example, if AI models are is to be deployed for performing channel estimation based on sounding reference signal (SRS), at least the following engineering issues need to be addressed beforehand: (i) types of radio frequency impairments that should be handled by the AI models, preprocessing algorithms or post-processing algorithms; (ii) incompatibility or inoperability of low complexity AI models in certain situations; (iii) life cycle management such as health monitoring, retraining or backup alternatives to support failure-safe operation; and/or (iv) collecting reliable training data to ensure robust performance of the AI models. However, these engineering issues remain unresolved.

The present disclosure provides AI-aided channel estimation methods and apparatuses that effectively resolve these issues as discussed in detail below.

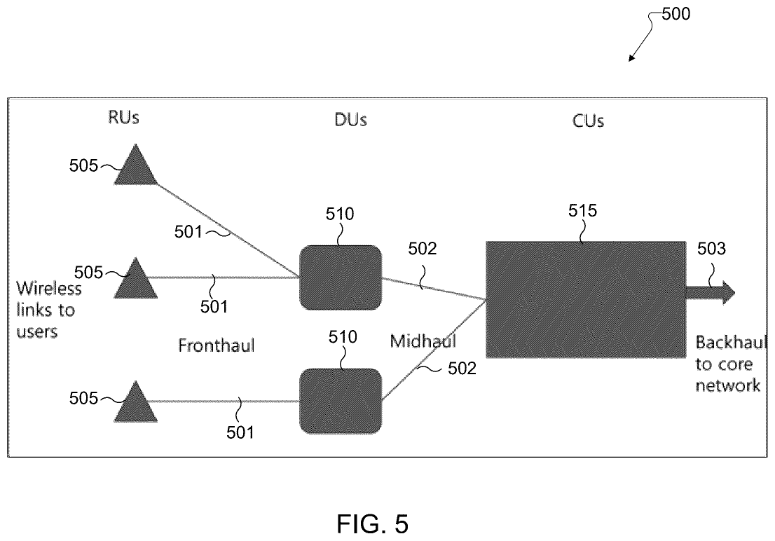

FIGS. 5-20 illustrate non-limiting embodiments of the AI-aided channel estimation methods and apparatuses, the resultant benefits, and related concepts thereof in greater detail in accordance with the present disclosure.

FIG. 5 illustrates an example radio access network (RAN) 500 according to embodiments of the present disclosure. As illustrated in FIG. 5, the RAN 500 may be a disaggregated RAN, which may be split into radio units (RUs) 505, distributed units (DUs) 510 and centralized units (CUs) 515. A CU 515 may provide a connection to a core network via a backhaul link 503, and communicate with one or more DUs 510 via a midhaul link 502. It may be the most centralized processing block in the RAN 500 since the data is passed on to a core network over the backhaul link 503 after the CU 515. A DU 510 may be an electronic device (e.g., a base station 101-103 of FIGS. 1 and 2) and provide network functions such as radio link control (RLC) or medium access control (MAC) functions. It may communicate with one or more RUs 505 to provide lower layer network functions, such as lower layer physical (PHY) and/or radio frequency (RF) functions. One or more RUs 505 may provide direct RF connection with one or more UEs or other nodes. Thus, in the RAN 500 a classical transmit/receive chain for uplink and downlink is split across the RUs 505, the DUs 510 and the CU(s) 515 based on factors such as a need for centralized compute, complexity requirements to the RUs 505 that include actual radio frequency (RF) antennas, and consequential requirements on capacity of a fronthaul link 501 and a midhaul link 502.

As shown in FIG. 5, multiple RUs 505 may be connected to a DU 510 and multiple DUs 510 may be connected to a CU 515. In some examples, the RAN 500 may provide an open RAN (O-RAN) architecture that allows interoperability between cellular network equipment provided by different mobile service providers, thereby allowing spectrum sharing by the mobile network providers while differentiating their key performance indicators (KPIs). For purposes of channel estimation, the present disclosure utilizes a normalized mean squared error (NMSE) in dB scale as a KPI. The channel estimation performance may be inversely proportionate to the NMSE.

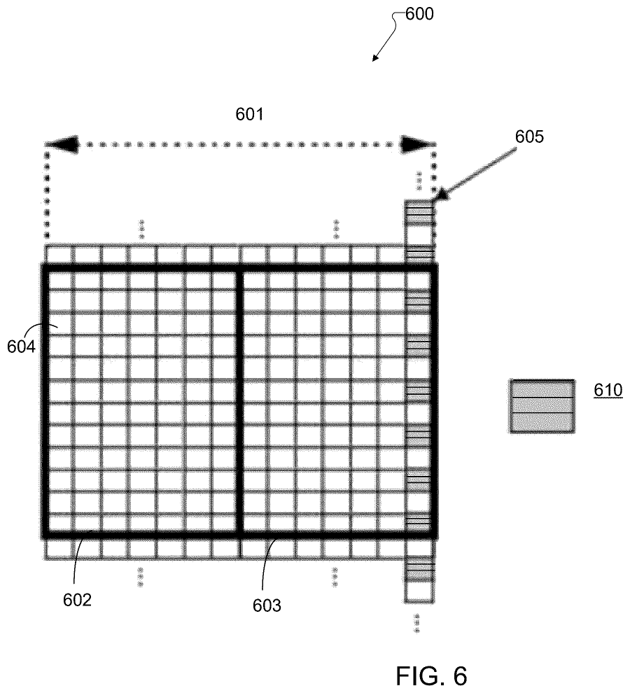

To enhance the uplink and downlink Tput performance, wireless channel estimation may be performed by one or more RUs 505 and/or DUs 510. Sounding reference signals (SRSs) are known pilots transmitted from a UE to enable an RU 505 and/or a DU 510 to perform the channel estimation, as illustrated in FIG. 6.

FIG. 6 illustrates an example time-frequency grid 600 including placement of a sounding reference signal (SRS) in an uplink slot 603 of an OFDM system according to embodiments of the present disclosure. The SRS may be transmitted via its allocated resource elements within the time-frequency grid having a number of resource elements (REs) 604. An RE may comprise one OFDM symbol period and one subcarrier, where the symbol period and subcarrier spacing are inversely related. In FIG. 6, the x-axis represents time (a subframe 601 including slots 602,603) and the y-axis represents orthogonal and equally spaced subcarriers. An OFDM symbol 605 may be utilized for the SRS and subcarriers 610 may be allocated to carry the SRS. The SRS may be transmitted in 1, 2 or 4 consecutive slots and within the last 6 OFDM symbols of a UL slot 603. The SRS may cover the entire bandwidth and each SRS may have a comb structure. In LTE, a comb-2 structure is supported, and in 5G/NR, a comb-2 structure and a comb-4 structure are supported for each SRS. In FIG. 6, the SRS has the comb-2 structure.

The SRSs are known pilots that are transmitted to enable wireless channel estimation. The SRS pilots may be first transmitted by a UE and noisy SRSs may be received at a base station (e.g., a gNB 101-103 of FIGS. 1 and 2, an RU 505 or a DU 510 of FIG. 5). The base station may next perform channel estimation based on the received SRSs. The base station may then utilize the estimated wireless channel for, e.g., uplink channel aware scheduling, precoder matrix index (PMI) selection, etc. Thus, channel estimation (e.g., SRS-based channel estimation) may play a critical role in increasing throughput (Tput) in wireless communication systems.

Channel estimation (CE) may be defined as estimating channel H_{N}_{_{sc}}_{×N}_{ₐₙₜ} given received noisy SRS signals Y_{N}_{_{sc}}_{×N}_{ₐₙₜ}. The transmitted SRS pilots may contain known Zadoff Chu sequences X_{N}_{_{sc}}_{×N}_{ₐₙₜ}. The received noisy SRS signals may be provided as follows:

$${Y}_{{N}_{sc} \times {N}_{ant}} = {H}_{{N}_{sc} \times {N}_{ant}} {oX}_{{N}_{sc} \times {N}_{ant}} + {N}_{{N}_{sc} \times {N}_{ant}} \qquad ( Eq . 1 )$$

where o represents an element wise multiplication. After the Zadoff Chu sequence removal or decorrelation at the receiver, the least squares estimate of the channel Z=Y/X=H+N (the element wise division) may be obtained. This noisy channel estimate Z is then denoised to obtain noiseless channel H. This may be executed utilizing linear minimum mean squared error estimate (LMMSE). However, the complexity of the LMMSE may become prohibitively high as the antenna dimensions and subcarrier dimensions increase. In some examples, a lower complexity moving average (MA) algorithm, which exploits a high correlation across subcarriers to denoise a wireless channel, may be utilized.

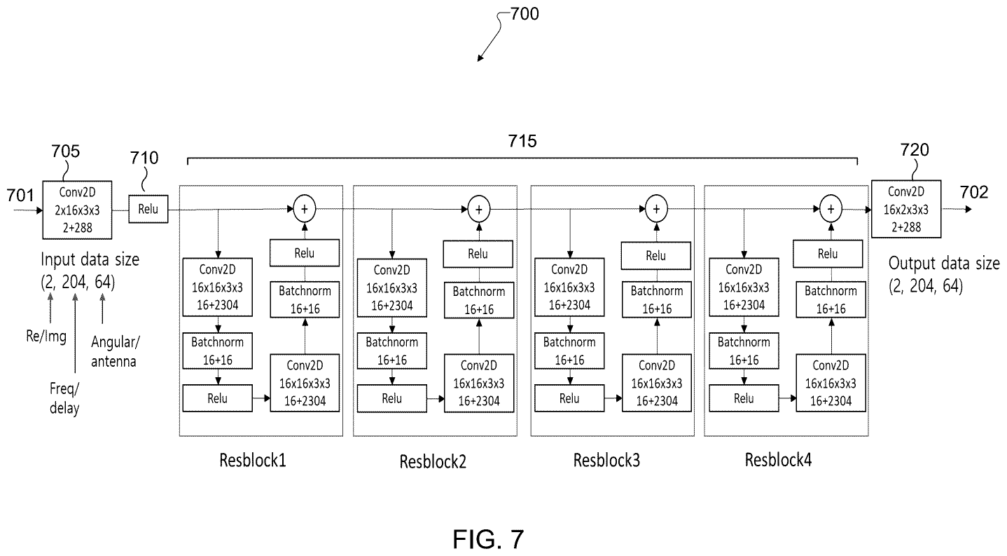

To deploy an AI model for performing channel estimation based on SRS, however, some fundamental issues need be answered. For example, it needs to be determined what preprocessing of the received signals may be needed before feeding them to the AI model in order to ensure robustness with respect to timing offset, inter cell interference and multiuser interference from same cell. Further, a key challenge with deploying the AI algorithms may be the increased computational complexity as compared to their non-AI counterparts, while concerns about whether the AI algorithms could continue to outperform the non-AI counterparts in all scenarios remain. Thus, to make a case of initial AI models to be deployed into a wireless communication network (e.g., the network 100 of FIG. 1 or the RAN 500 of FIG. 5) more persuasive, it may be critical to identify low complexity architectures of the AI models. Nevertheless, since a low complexity architecture deployed in one scenario may not work in other scenarios, it should be determined how low complexity architectures may be adaptively learned on the fly. In addition, it may also be determined as to how often retraining may be required for the site-specific AI models and how the wireless communication network may obtain such indication. Furthermore, other issues such as the possibility of the failure to converge after training, availability of backup alternatives to support failure-safe operation, the ability to redress any loss of temporal coverage during training, and means to collect labels for training without relying on simulation data which may have issues generalizing in field environments and so forth may also need to be addressed. The AI-aided CE methods and apparatuses resolves these issues as discussed further in detail with reference to FIGS. 7-20.

FIG. 7 illustrates an example baseline AI CE model 700 according to embodiments of the present disclosure. The baseline AI CE model 700 includes two-dimensional (2D) convolutional neural networks (Conv2D) 705 and 720, a ReLU 710, and one or more residual learning networks (ResNets) 715 for performing CE. While FIG. 7 shows one ResNet 715 with 4 Resblocks, this is for illustrative purposes only, and thus the baseline AI CE model may include any number of ResNet 715 as appropriate without departing from the scope of the present disclosure. A ResNet may also be referred to herein as a ‘Vanilla ResNet model.’

The noisy channel (also referred to herein as the noisy image, the noisy channel estimate, or the noisy channel data) 701 may be input to the Conv2D 705, which may extract features from the noisy channel input. The noisy channel 701 may have an input data size of, e.g., without limitation, two channels (real and imaginary), 204 frequency bins or delay taps, and 64 angular directions or antennas. The extracted features may then pass through the ReLU 710 for positive activation, and then to the ResNet 715 to perform residual operations and denoising of the noisy channel.

The ResNet 715 may include one or more Resblocks and each Resblock may include two sets of a standard Conv2D, a batch normalization (BN) and a ReLU, and an elementwise addition. Thus, the AI CE model 700 may be trained with the standard 2D convolutions. The last Resblock may then input a denoised channel estimate into the final Conv2D 720 for enhancement, which may output the final denoised channel estimate 702. The denoised channel estimate (also referred to herein as the denoised channel, denoised image or denoised channel matrix) 702 may have the same data size as the noisy channel estimate 701.

Although FIG. 7 illustrates one example of baseline AI CE model, this is for illustrative purposes only, and thus various changes may be made to FIG. 7 as appropriate without departing from the scope of the present disclosure.

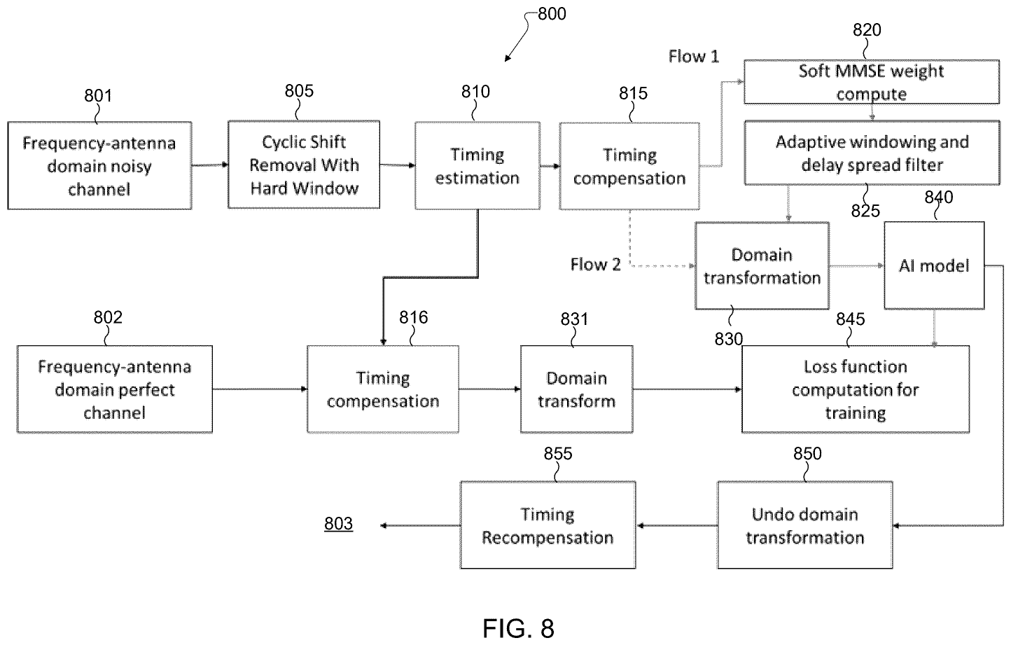

FIG. 8 illustrates an example pipeline 800 of an AI CE method according to embodiments of the present disclosure. The training and testing of an AI CE model 840 may be executed by a network device (e.g., a network server 132 of FIGS. 1 and 4, an RU 505 or a DU 510 of FIG. 5). The AI CE model 840 may be native and/or remotely located.

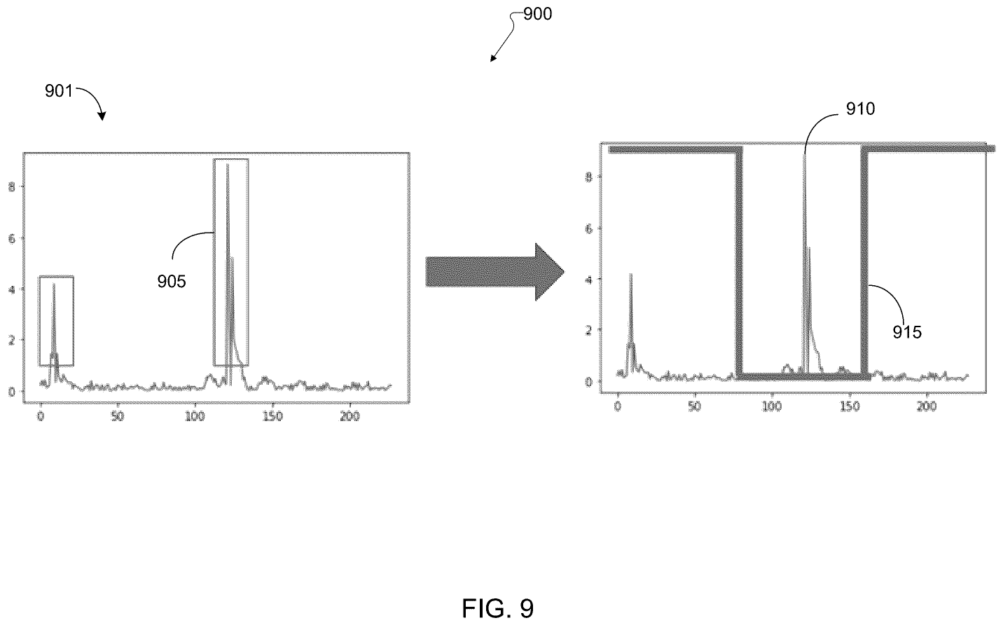

As illustrated in the example of FIG. 8, the input noisy channel 801 may be the least squares estimate after decorrelation of the known Zadoff-Chu sequence filled in the SRS pilots received at a base station (e.g., a gNB 101-103 of FIGS. 1 and 2, an RU 505 or a DU 510 of FIG. 5). The noisy channel 801 may be in the frequency-antenna domain and fed as an input to a preprocessing pipeline. The preprocessing may begin with a transform operation from the frequency-antenna domain to a delay domain if the AI CE model 840 receives delay domain inputs. If the AI CE model 840 receives frequency domain inputs, no transform may be performed. After converting the noisy channel 801 to the delay domain, the network device may first perform a cyclic shift (CS) window removal 805 utilizing a hard window. This window may be applied to remove the multiuser interference (MUI) from the same cell (CS-2 assumption), as discussed further in detail with reference to FIG. 9.

Next, the network device may perform additional essential preprocessing operations such as timing estimation 810 and timing compensation 815, which may be performed in delay or frequency domain. The timing estimation 810 and timing compensation 815 may be critical in providing a robust performance of the AI CE model 840 in the delay domain. For example, it has been shown that performance of ResNet-aided channel estimation without providing the timing compensation can be significantly degraded, when the AI model was trained and tested based on a different timing offset impairment. Whereas, it has also been shown that if timing compensation is explicitly added as part of the preprocessing then the performance of the ResNet-aided channel estimation may be robust to such variations in the NMSE KPI.

The timing estimation 810 in the frequency domain may include the following steps:
Step 1: Obtain a timing offset estimate t from the frequency domain signal X_{f} (this signal may be for fixed antenna)
   For a given lag setting l, compute the average of hₖ [symbol] over k to obtain exp(j2π [symbol] Δ_{f}τ), where a typical lag is set around 2 to 4, and Δ_{f} is subcarrier spacing
Step 2: Generate candidate TOs {τ_{±1}, . . . , τ_{±10}}, adding jumps of ±2 ns
Step 3: For each candidate TO i∈{−10, . . . , 10}, perform the following
   X_{f}→X_{f,i} to obtain a timing compensated signal

$${X}_{f , i} = {X}_{f} exp ( j 2 {πΔ}_{f} {τ}_{i} )$$

Convert to delay domain X_{f,i}→x_{t,i}
Compute max power of signal, Pᵢ
Step 4: Select the candidate TO with the largest Pᵢ as the final TO estimate.
   It has been found that employing the hypothesis testing (Steps 2 to 4 above) to select the maximum signal peak at a high signal to noise ratio (SNR) further improves the timing estimation accuracy, especially at a high SNR with the tapped delay line A (TDL-A) channel type. It has also been shown that the performance of Step 4 as compared to the performance of Step 1 further improves the ResNet CE performance for this channel type. The jump size in Step 2 and the range of i in Step 3 may depend on the sample duration of each delay tap.

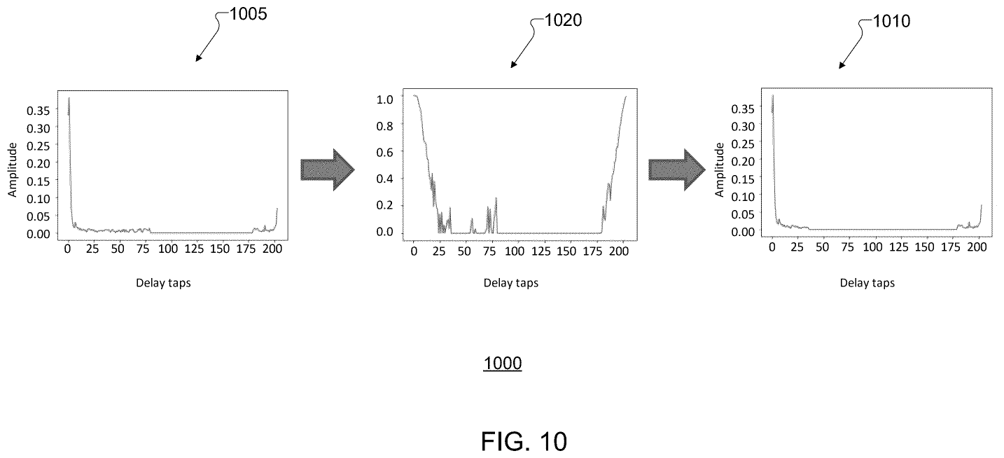

Before inputting the timing compensated noisy channel to the AI CE model 840, the noisy channel may undergo further preprocessing operations including a soft MMSE weight computation 820 and an adaptive windowing and delay spread filtering 825 as discussed further in detail with reference to FIG. 10. After the adaptive windowing and delay spread filtering 825, the noisy channel may undergo another domain transformation 830 as appropriate. The noisy channel in the delay domain may then be input to the AI CE model 840 for training. The output of the AI CE model 840 may be provided for a loss function computation 845.

Simultaneous to the preprocessing of the noisy channel 801, frequency-antenna domain perfect channel (also referred to herein as the label, noiseless channel, or noiseless image) 802 may also undergo appropriate preprocessing operations including timing compensation 816 based on the timing estimation 810 of the noisy channel 801, and a domain transformation 831. The timing compensation 816 may be performed to adjust the label 802 to account for the delays (TOs) observed in the noisy channel 801. The domain transformation 831 may transform the label 802 from the frequency domain to the delay domain for the loss function computation 845, which typically is performed in the delay or time domain.

The loss function computation 845 may be performed to obtain the discrepancy between the timing compensated label and the denoised channel estimate output from the AI CE model 840. This may utilize metrics such as the NMSE, mean squared error (MSE), mean absolute error (MAE) or other appropriate measures. The calculated loss may assist with evaluating the performance of the AI CE model 840 and adjusting parameters of the AI CE model 840, if needed.

The AI CE model output, during testing or inferencing, may undergo postprocessing including a domain detransforming 850 and a timing recompensation 855. The postprocessed AI CE model output 803 may then be utilized for, e.g., uplink channel aware scheduling, precoder matrix index selection, etc.

Although FIG. 8 illustrates one example pipeline of the AI-aided channel estimation method, this is for illustrative purposes only, and thus various changes may be made to FIG. 8 as appropriate without departing from the scope of the present disclosure.

FIG. 9 illustrates an example cyclic shift windowing 900 to remove a multiuser interference (MUI) 905 from a noisy channel 901 according to embodiments of the present disclosure. As illustrated in the example of FIG. 9, an example delay domain signal diagram indicates the noisy channel encountering an interference 905 from another UE. The MUI may be removed by applying a hard (fixed) window 915 over the interfering peak 910.

The window taps may be fixed or configurable. As shown in FIG. 9, the configurable window taps may utilize the following algorithm: (i) declare an interfering peak as the largest peak in the second half of the delay taps or in the last T taps of the first half (to account for negative timing offsets for the interfering signal); and (ii) centered around the interfering peak, window the interfering signal with, e.g., ±50 delay taps (need not be symmetric), which has the inherent assumption on the delay spread of the interfering signal.

FIG. 10 illustrates an example pipeline 1000 for performing adaptive windowing 1010 based on soft MMSE weights computation 1020 according to embodiments of the present disclosure. The adaptive windowing 1020 may be performed on the timing compensated noisy channel 1005 with a cyclic shift removal of MUIs using a fixed window. Soft MMSE weights may be obtained by:
Computing a noise power estimate σ² using a power delay profile (PDP)-sorting followed by selecting specified indices for the computing estimate; and

$$Computing \frac{PDP - {σ}^{2}}{PDP} as soft MMSE weights .$$

An adaptive window may be then identified by applying a σ² dependent threshold to the soft MMSE weights. The window may be determined by the last sample in the first half above the threshold and the first sample in the second half above the threshold.

It has been found that the adaptive windowing can help with low SNR performance, especially when the signal to interference ratio (SIR) is high (e.g., 10 dB). The TDL-A channel type may be used for the pilot.

The adaptive windowing 1010 may then further clip the noise (MUIs) using power delay spread filtering. The delay spread may be greater than, e.g., 600 ns. The power delay profile (PDP) estimated during the adaptive windowing can also be used to obtain a delay spread estimate. In particular, the PDP computed during the adaptive windowing can be used to compute delay taps until the maximum energy (e.g., 90% of total energy) is captured. This may be then used to compute the delay spread estimate. The delay spread estimate can be used to perform an optional delay spread filtering removal of the input data to the AI CE model. It has been shown that a significant improvement in the final NMSE performance (e.g., −21.5 dB) may be achieved by a model with the delay spread filtering as compared to that (e.g., −16 dB) of a baseline model without the delay spread filtering.

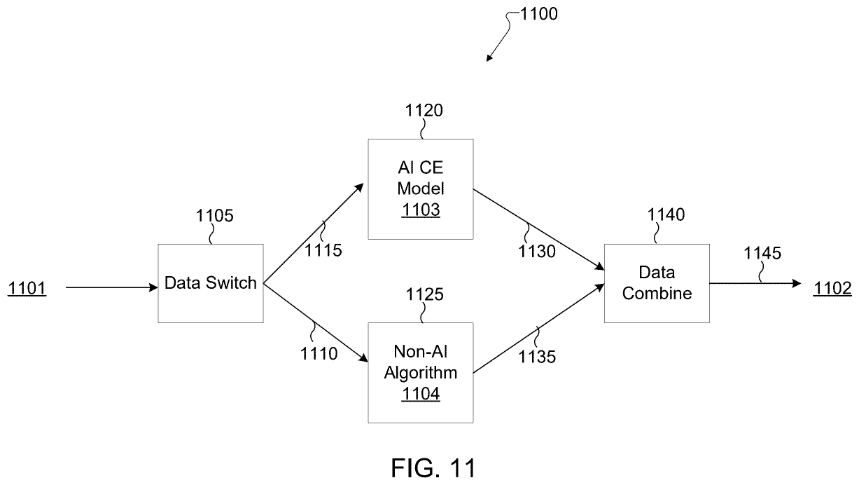

In some examples, the data that is delay spread filtered may be denoised using non-AI algorithms as discussed in further detail with reference to FIG. 11.

FIG. 11 illustrates an example data offloading method 1100 between an AI CE model 1103 and a non-AI model 1104 according to embodiments of the present disclosure. The method 1100 may be performed by a network device (e.g., a network server 132 of FIGS. 1 and 4, an RU 505 or a DU 510 of FIG. 5) and the models 1103 and 1104. As illustrated in the example of FIG. 11, the method 1100 begins at step 1105.

At step 1105, the network device may determine that the data of the noisy channel 1101 includes a first portion having at least one of signal to noise ratio (SNR) or delay spread greater than a threshold. The network device may estimate the SNR or delay spread and determine whether the SNR or delay spread is greater than a respective threshold at any portion of the noisy channel data 1101. As discussed previously, the power delay profile (PDP) estimated during the adaptive windowing design may be used to estimate the delay spread.

At step 1110, the network device may divert the first portion having the SNR or delay spread greater than the respective threshold to the non-AI model 1104 running in parallel to the AI CE model 1103. In some embodiments, the non-AI model 1115 may begin to operate based on the determination that the noisy channel data 1101 includes the first portion. At step 1115, the network device may input the remaining portion of the noisy channel data 1101 to the AI CE model 1103.

At step 1120, the AI CE model 1103 may denoise the remaining portion of the noisy channel data 1101. At step 1125, the non-AI model 1104 may denoise the first portion of the noisy channel data 1101. Steps 1120 and 1125 may be performed simultaneously. At step 1130, the AI CE model 1103 may output the denoised remaining portion to the network device. At step 1135, the non-AI model 1104 may output the denoised first portion to the network device.

At step 1140, the network device may combine the denoised first portion and the denoised remaining portion and perform channel estimation based on the combined denoised first and remaining portions.

At step 1145, the network device may output the estimated channel 1102.

In the example of FIG. 11, the SNR and/or the delay spread higher than respective thresholds may be utilized as a criterion for diverting data to the non-AI model 1104. This is because it has been shown that some AI CE models may provide significantly more benefits at a low SNR regime than a high SNR regime and that a high delay spread may limit some of the preprocessing operations. In other words, some non-AI models may perform better with lower complexity for the high SNR/delay spread denoising than some AI CE models. Thus, by offloading to non-AI models to aid the high SNR/delay spread-based channel estimation, the method 1100 allows the AI CE model to primarily aid the low SNR/delay-based channel estimation, thereby reducing the computational costs and enhancing the channel estimation performance overall.

While FIG. 11 utilizes the high SNR and/or delay spread for the data offloading, this is for illustrative purposes only and thus any other appropriate metrics may be utilized for the data offloading without departing from the scope of the present disclosure.

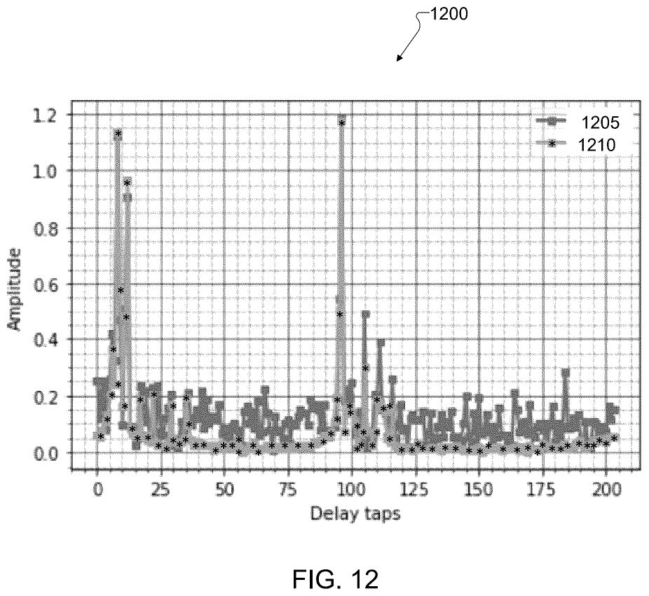

FIG. 12 illustrates example noisy channels 1205 and 1210 according to embodiments of the present disclosure. The noisy channel 1205 may include intercell interference (ICI) and the noisy channel 1210 may not include ICI.

In cellular systems, the users from neighboring cells may use a different Zadoff Chu sequence than a target cell. Unlike the multiuser interference, the ICI may lead to an increased noise floor for all delay taps. Thus, the noisy channel 1205 with the ICI has an increased noise floor as compared to the noisy channel 1210 without the ICI as shown in FIG. 12.

The increased noise floor due to the ICI, however, may not be white Gaussian. Further, in TDL channels the ICI may appear as additive white Gaussian noise (AWGN) whereas in urban microcell (UMi) channels the ICI distribution may not be Gaussian. Hence, an AI model trained with a Gaussian noise may not work with a non-Gaussian additive noise and its performance may degrade significantly as compared to that of a non-AI model (e.g., a non-AI baseline moving average algorithm). It has been shown that where an AI model has received the ICI-aware training with a random interference to noise ratio (INR) selected from, e.g., between −10 dB to 10 dB, the model performance may be robust to the ICI impairment, and also the degradation in no ICI case may be <1 dB in terms of the NMSE. As such, training or retraining an AI model with the ICI may improve the performance for the UMi channel type. It has also been shown that the performance of an AI model may be highly sensitive to conditions in which the ICI simulations were included during training. For example, if the INR distribution is skewed, e.g., between 10 dB to 20 dB, then the ResNet performance may suffer, and thus it may need to be ensured that such a scenario does not arise.

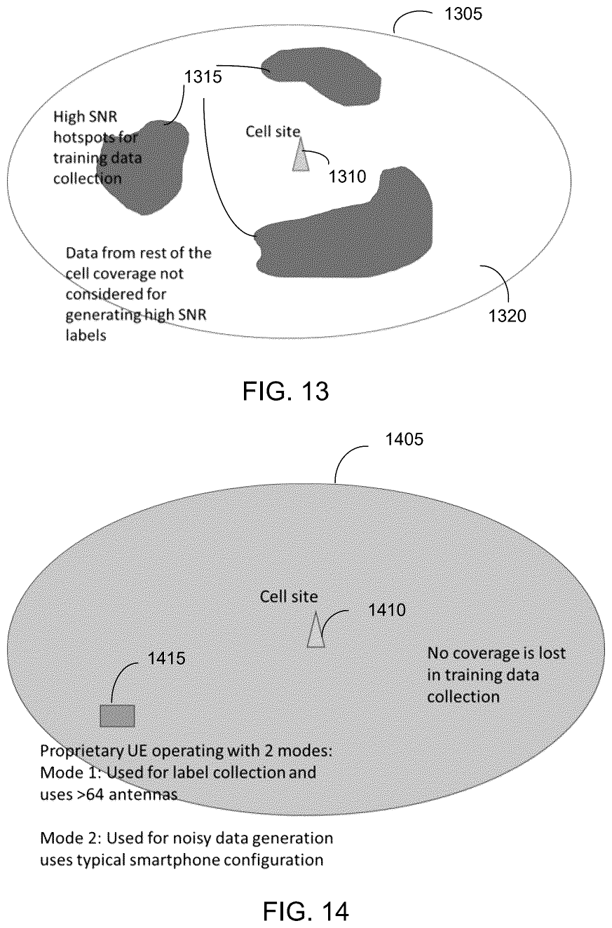

In one embodiment, to enable robust training, instead of relying on the AWGN denoising for training, the AI CE model of the present disclosure may be trained to denoise other types of noise distributions that one would encounter as well. Thus, if a high SNR data is used as a label for training the AI CE model, the corresponding noisy data may be generated using simulation, but the noise added may contain the distributions of interest and not just the AWGN. However, collecting the realistic field data such as the high SNR data without a loss of coverage area may be challenging as illustrated in FIG. 13.

FIG. 13 illustrates an example cell 1305 according to embodiments of the present disclosure. In FIG. 13, a base station 1310 (e.g., gNB 101-103 of FIGS. 1 and 2, an RU 505 or a DU 510 of FIG. 5) may provide a cell coverage within the cell 1305. As can be seen in FIG. 13, not all locations can receive good coverage, however. That is, while a number of hotspots 1315 may have a high signal to noise ratio (SNR), the remaining area 1320 suffers from a low SNR. Hence, the cell edge users in the remaining area 1320 may not be able to contribute to creating the high SNR labels. The present disclosure resolves this challenge by providing a dedicated sounding device (also referred to herein as a training data collection module) as discussed further with reference to FIG. 14.

FIG. 14 illustrates an example sounding device 1415 employed in a cell 1405 according to embodiments of the present disclosure. The sounding device 1415 may be dedicated solely to collect training data for the AI CE models. It may be provided by a network operator, gNB manufacturer or third-party for collecting training data for AI CE models.

The dedicated sounding device 1415 may have two modes of operation. In the first mode of operation, the equipment 1415 may use, e.g., 64 or more antennas for transmitting the sounding reference signal (SRS) to a serving cell 1410. In the second mode, the equipment 1415 may emulate smartphone transmission with, e.g., 4 antennas or less. The data collected from the first mode may serve as a high SNR perfect labels and the data collected from the second mode may serve as a noisy data transmission. Together with these two modes, a supervised learning dataset collection mechanism can be defined. The high-quality training data collected by the dedicated sounding device 1415 may be shared across the vendors to reduce the cost of training data generation.

It is noted that even if the field data may be collected using such a dedicated sounding device 1415, it may need to be ensured that the training data is balanced and extreme conditions (e.g., conditions with no intercell interference (ICI) or with only heavy ICIs) are avoided. In one embodiment, the training data may not be collected during low traffic hours, e.g., between 1 a.m. and 3 a.m., when the data collected may have no ICI. Similarly, collecting data may be avoided during extraordinarily high traffic conditions, e.g., a game taking place at a stadium when there are numerous small cells with several interfering users.

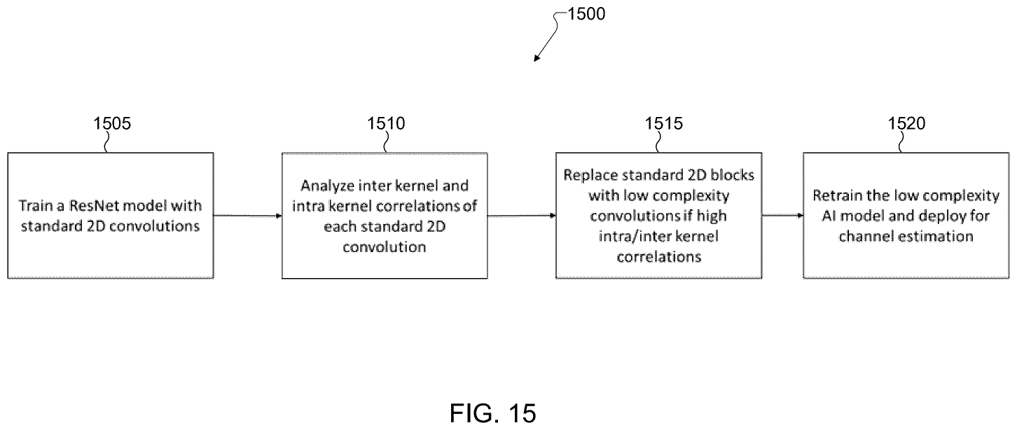

FIG. 15 illustrates an example model complexity switching method 1500 according to embodiments of the present disclosure. The method 1500 may be performed by a network device (e.g., a network server 132 of FIGS. 1 and 4, an RU 505 or a DU 510 of FIG. 5).

As previously mentioned, a major issue in deploying an AI model is the complexity. AI models have a dimensionality with tens of thousands of parameters being learned and also the floating-point operations per second that are much larger than their non-AI counterparts. Thus, it may be critical to have low complexity variants of the AI models.

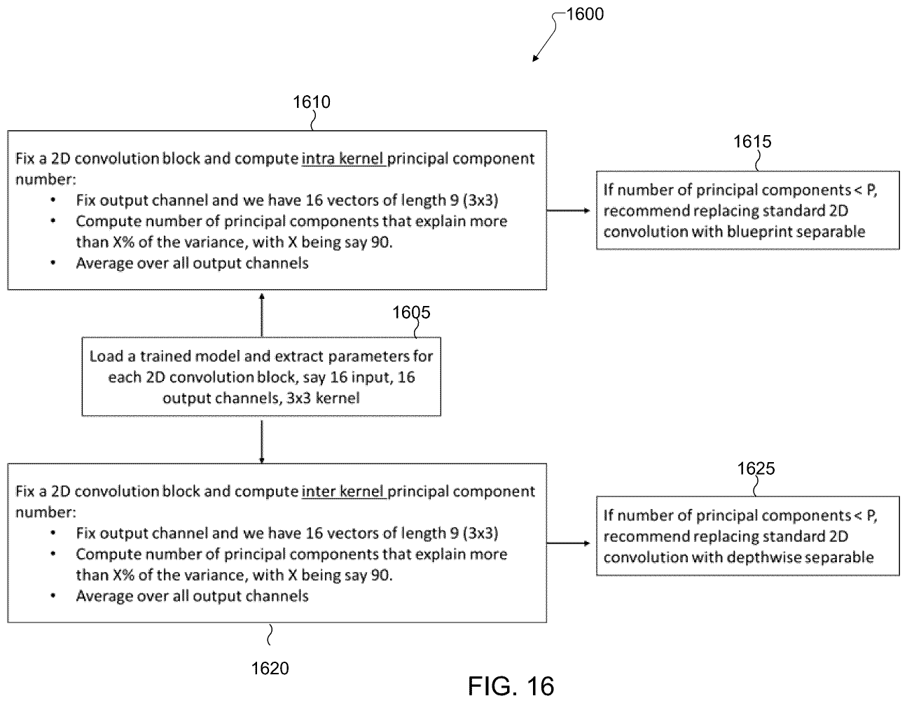

As illustrated in the example of FIG. 15, the method 1500 begins at step 1505. At step 1505, the network device may train an AI CE model with standard two-dimensional (2D) convolutions (e.g., the Conv2Ds in the ResNet 715 in FIG. 7). At step 1510, the network device may analyze the model parameters. For example, the network device may analyze intra- or inter-kernel (intra/inter) correlations of each standard 2D convolution, as discussed further in detail with reference to FIG. 16.

At step 1515, the network device may replace the standard 2D convolution blocks in the AI CE model with low complexity convolutions based on the high intra/inter kernel correlations.

At step 1520, the network device may retrain and deploy the low complexity AI CE model for channel estimation.

FIG. 16 illustrates an example flowchart of an intra/inter-kernel correlations computation method 1600 according to embodiments of the present disclosure. The method 1600 may be performed by a network device (e.g., a network server 132 of FIGS. 1 and 4, an RU 505 or a DU 510 of FIG. 5).

As illustrated in the example of FIG. 16, the method 1600 begins at step 1605. At step 1605, the network device may load a trained AI CE model (e.g., the AI CE model 700, 840 or 1103 of FIGS. 7, 8, and 11) and extract model parameters for each 2D convolution block having, e.g., 16 input channels, 16 output channels and 3×3 kernel.

At step 1610, the network device may fix a 2D convolution block and compute intra-kernel principal component number as follows:
Fix an output channel, resulting in 16 vectors of a length 9 (3×3)·
Compute the number of the principal components that explain more than X % of the variance, where X may be, e.g., 90
Average over all of the output channels.

If the number of the principal components is less than a threshold (e.g., 6), the network device may recommend replacing the standard 2D convolutions (e.g., Conv2Ds in the ResNet 715 of FIG. 7) with blueprint separable convolutions at step 1615. That is, the 2D convolution blocks having the number of the intra-kernel principal components below the threshold may be replaced with a low complexity blueprint separable convolutions.

At step 1620, the network device may fix a 2D convolution block and compute inter-kernel principal component number as follows:
Fix an output channel, resulting in 16 vectors of a length 9 (3×3)·
Compute the number of the principal components that explain more than X % of the variance, where X may be, e.g., 90
Average over all of the output channels.

If the number of the principal components is less than a threshold, the network device may recommend replacing the standard 2D convolutions with depthwise separable convolutions (DSCs) at step 1625. That is, the 2D convolution blocks having the number of the inter-kernel principal components below the threshold may be replaced with low complexity DSCs.

It has been shown that by replacing the standard 2D convolutions in the last two Resblocks with two low complexity DSCs or blueprint separable convolutions, the complexity may be reduced significantly (e.g., by 50%) while the loss in the NMSE KPI remains low (e.g., approximately, 1.2 dB).

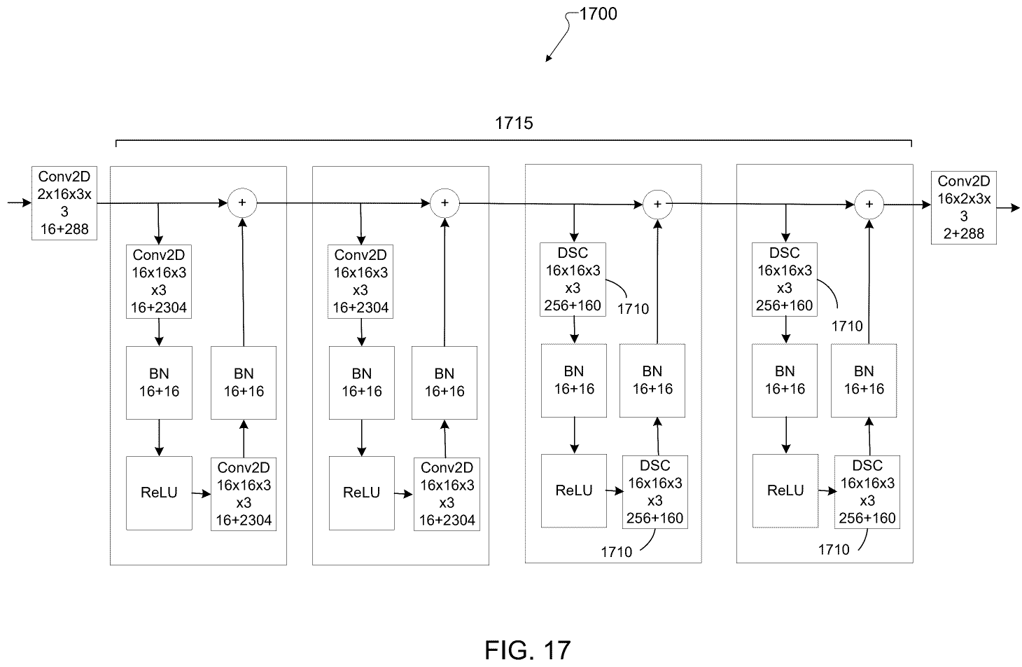

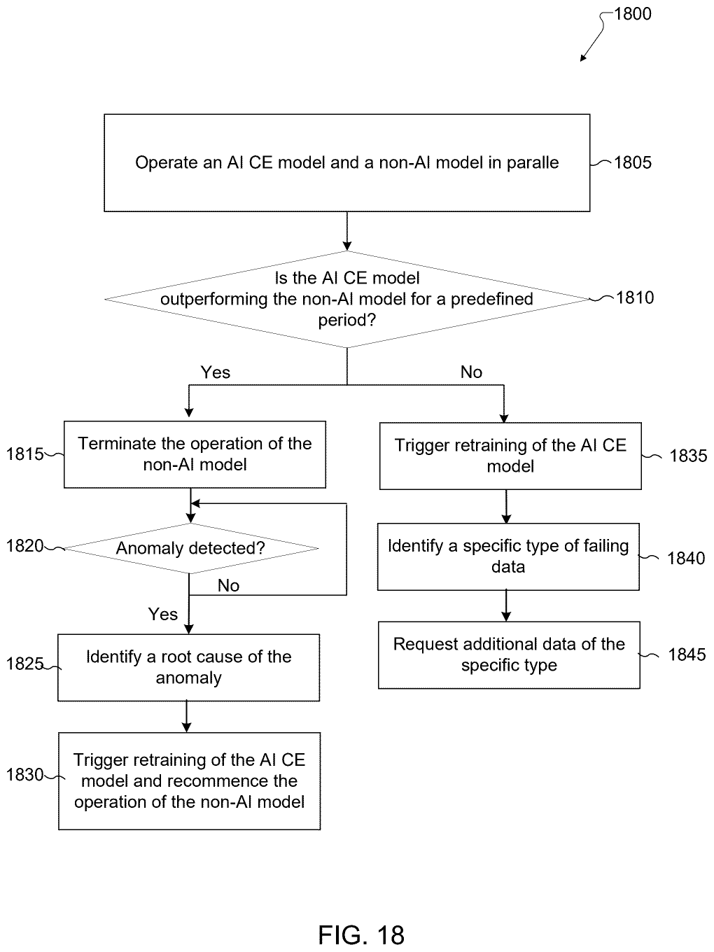

FIG. 17 illustrates an example low complexity AI CE model 1700 according to embodiments of the present disclosure.

The AI CE model 1700 may be similar to the baseline AI CE model 700 in FIG. 7, but differ in that the last two Resblocks of the AI CE model 1700 include low complexity DSCs, rather than the standard 2D convolutions as in FIG. 7. That is, the DSCs may have replaced the standard 2D convolutions based on a determination that the number of inter-kernel principal components in the standard 2D convolutions may have been less than a threshold (e.g., 6).

As mentioned previously, by replacing the standard 2D convolutions with low complexity DSCs, the complexity may be reduced significantly while the loss in the NMSE KPI remains low.

FIG. 18 illustrates an example retraining model health monitoring and retraining method 1800 according to embodiments of the present disclosure. The method 1800 may be performed by a network device (e.g., a network server 132 of FIGS. 1 and 4, an RU 505 or a DU 510 of FIG. 5).

Some AI models may not get trained correctly due to variation in distribution of data collected for training and validation. In such cases, the training and validation curves may not converge. A poorly converged AI CE model can have several jumps in the validation or training losses, which may require retraining of the models. Further, the network device performing the training may need to raise a request (e.g., a flag) to collect more data.

An automatic way to detect the need for retraining may be selecting last E (e.g., 100) epochs. The standard deviation of the observed training and validation plots should be less than a threshold individually and the gap between the training and validation losses should be less than a threshold. The flag for retraining could be generic or specific. For example, a request may be more specific than requesting more data in terms of X (e.g., 10,000) samples or from a specific coverage region of the site where the channel estimation performance may be poor. For having a specific request for retraining, there may need to be additional processing blocks to identify this. For instance, if it is identified that the data with a specific characteristic such as a large delay spread is performing poorly, then a specific request for a large delay spread data may be made. Similarly, if the ICI has a skewed distribution during training data collection (absent or heavy interference), retraining may be triggered.

In some cases, despite the initial successful automatic checks on the training of the AI CE model, the model performance in practice may suffer. The method 1800 provides retraining triggering mechanism in those cases.

As illustrated in the example of FIG. 18, the method 1800 begins at step 1805. At step 1805, an AI CE model of the present disclosure and a non-AI model may operate in parallel.

At step 1810, the network device may determine whether the AI CE model consistently outperforms the non-AI model in terms of a key performance indicator (KPI) for a predefined period, e.g., one hour. In one embodiment, the network device may determine whether the AI CE model consistently outperforms the non-AI model in terms of a KPI for a fixed amount of served traffic (e.g., 10 MB). In one embodiment, the network device may determine that the AI CE model consistently outperforms the non-AI model if the CE performance of the AI CE model is higher than the CE performance of the non-AI model over a predefined number of CEs performed.

If it is determined that the CE performance of the AI CE model is higher than the CE performance of the non-AI model for the predefined period, at step 1815 the network device may terminate the operation of the non-AI model and allow the AI CE model to continue to operate. The network device may continue to monitor the performance of the AI CE model. At step 1820, if the network device (e.g., an anomaly detection module therein) detects an anomaly, the network device may trigger a root cause analysis (RCA) of the anomaly. The RCA may identify that channel quality is poor as a result of consistently poor channel estimation performance. At step 1825, the RCA may identify a root cause of the anomaly. At step 1830, the network device may trigger retraining of the AI CE model and commence operating the non-AI model. The retraining may be triggered by a flag raised by the network device. In some cases, the RCA may identify that channel quality is bad as a result of consistently poor channel estimation performance.

If it is determined that the CE performance of the AI CE model is not higher than the CE performance of the non-AI model for the predefined period, at step 1835 the network device may terminate the operation of the AI CE model and trigger a flag to retrain the AI CE model. Optionally, at step 1840 a gNB vendor or operator may identify a specific type of data failing with the AI CE model. At step 1845, the network device may request more data of a specific type during retraining.

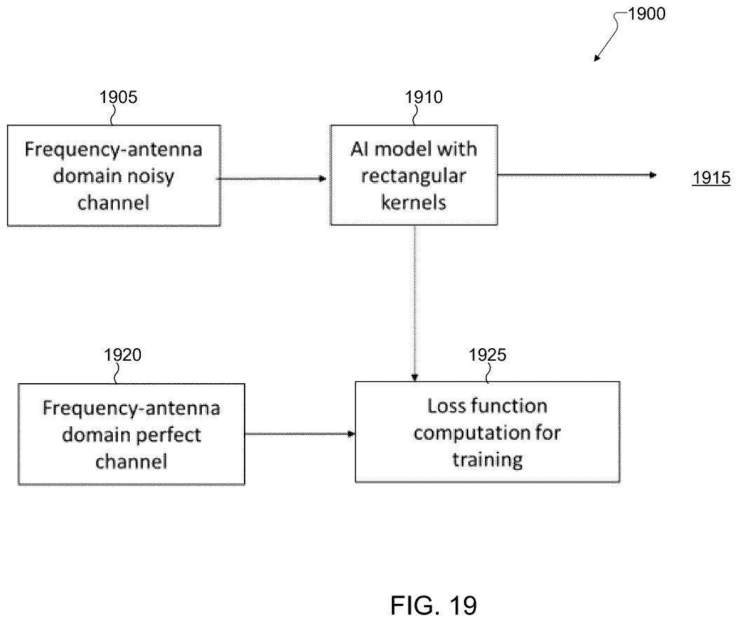

FIG. 19 illustrates an example pipeline 1900 of an AI CE model 1910 receiving a frequency domain input according to embodiments of the present disclosure.

As illustrated in the example of FIG. 1900, the AI CE model 1910 may directly receive a frequency-antenna domain noisy channel 1905. The AI CE model 1910 may perform denoising of the noisy channel 1905 and output the denoised channel 1915. A network device (e.g., a network server 132 of FIGS. 1 and 4, an RU 505 or a DU 510 of FIG. 5) may analyze the denoised channel output from the AI CE model 1910 and perform a loss function computation based on the frequency-antenna domain perfect channel for training and testing.

Directly inputting the frequency-antenna domain noisy channel to the AI CE model 1910 may likely lead to utilizing rectangular kernels, instead of square kernels, due to the added advantage of exploiting the correlation across neighboring subcarriers. Since the increased kernel size means increased complexity, dilations (dilated convolutions) in combination with rectangular kernels may be employed to increase the receptive field of each stride in the convolutions. It has been shown that the performance of the receiving the direct frequency domain noisy channel input ResNet (also referred to herein as the frequency domain ResNet) may improve with the dilations.

The performance of the frequency domain ResNet can be comparable to the performance of the ResNet in the delay domain with these modifications as well as the additional advantage of likely not requiring the explicit timing compensation in its preprocessing.

In one embodiment, the frequency domain ResNet may be first deployed and if the frequency domain ResNet performs the SRS-based channel estimation optimally, it may then be switched to the delay domain ResNet with a lower complexity by exploiting sparsity of the delay domain channel. This is because the frequency domain ResNet may be more robust to impairments including handling of multiuser interference as compared to the ResNet operating in the delay domain.

In one embodiment, the AI CE models (e.g., the AI CE models 700, 840, 1103, 1700 and 1910 of FIGS. 7, 8, 11, 17 and 19) may be shared. There can be scenarios where the AI CE models may need to be shared across different entities of the wireless communication network. For instance, a DU (e.g., a DU 510 of FIG. 5) may be sharing a trained model with an RU (e.g., an RU 505 of FIG. 5) or vice versa. Such scenarios may arise since a DU may have a much richer dataset than an RU for training the AI model. The model could be low complexity enabled and/or have different preprocessing methods to ensure their robustness. The compatibility across the different preprocessing methods and low complexity assumptions may not work across the entities sharing the AI CE model. In this case, when sharing an AI CE model, the exchange messages between the network entities may contain not only the model information including the learned parameters along with the architecture blocks, but should also contain the preprocessing that may be required for the model to work. For instance, an example message could contain meta information including whether a timing compensation is part of the preprocessing or not. The message could contain information regarding whether the model was trained with AWGN assumptions only or trained with additional impairments like the ICI. The message could also contain information regarding what fixed or adaptive windowing assumptions the model was trained on for dealing with multiuser interference from the same cell. It has been found that an AI CE model trained with timing compensation can fail if it were utilized without timing compensation and vice versa. Thus, including such messages may be critical when the entities are sharing the trained AI CE models.

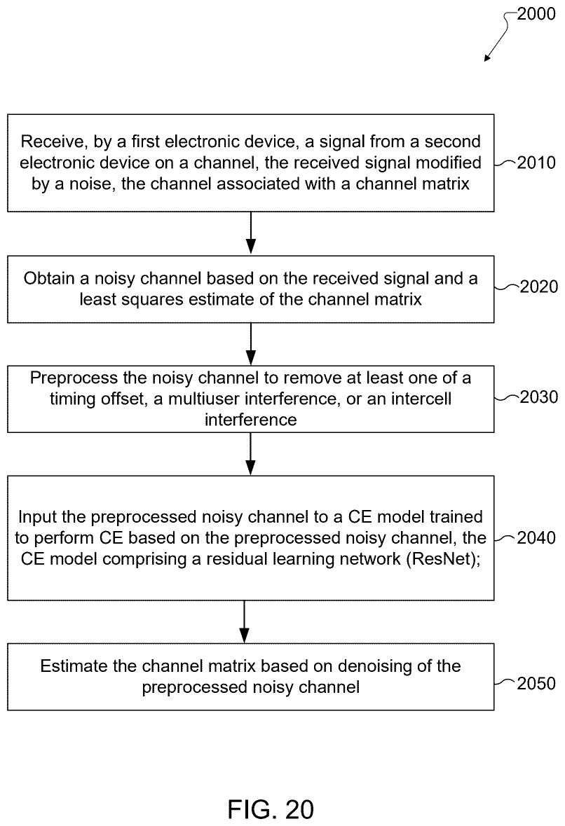

FIG. 20 illustrates an example flow chart for an AI-aided channel estimation method 2000 according to embodiments of the present disclosure. An embodiment of the method illustrated in FIG. 20 is for illustration only. One or more of the components illustrated in FIG. 20 may be implemented in specialized circuitry configured to perform the noted functions or one or more of the components may be implemented by one or more processors executing instructions to perform the noted functions. Other embodiments of data preparation could be used without departing from the scope of this disclosure.

As illustrated in FIG. 20, the method 2000 begins at step 2010. At step 2010, a first electronic device (e.g., a base station 101-103 of FIGS. 1 and 2, an RU 505 or a DU 510 in FIG. 5) may receive a signal from a second electronic device (e.g., a UE 111-106 of FIGS. 1 and 3 or an RU 505 of FIG. 5) on a channel. The received signal may be modified by a noise. The channel may be associated with a channel matrix.

At step 2020, the first electronic device may obtain a noisy channel based on the received signal and a least squares estimate of the channel matrix.

At step 2030, the first electronic device may preprocess the noisy channel to remove at least one of a timing offset (TO), a multiuser interference (MUI), or an intercell interference (ICI).

In one embodiment, preprocessing the noisy channel may include transforming the noisy channel from a frequency domain to a delay domain; removing an MUI from the noisy channel based on a cyclic shift window applied to one or more delay taps preceding and following an interfering peak of the MUI; retransforming the noisy channel with the MUI removed into the frequency domain; obtaining a TO estimate from the noisy channel; and applying a timing compensation to the noisy channel based on the TO estimate.

In one embodiment, preprocessing the noisy channel may include transforming the noisy channel from a frequency domain into a delay domain; removing an MUI from the noisy channel based on a cyclic shift window applied to one or more delay taps preceding and following an interfering peak of the MUI; obtaining a minimum mean square error (MMSE) of the noisy channel based on a power delay profile and a noise power estimate; identifying a window based on a threshold associated with the noise power estimate, the window comprising noises enhanced based on the MMSE; and removing the enhanced noises within the window.

In one embodiment, preprocessing the noisy channel may further include determining that noisy channel data includes a first portion having at least one of signal to noise ratio or delay spread greater than a threshold. The method 2000 may further include: inputting the first portion to a non-AI model running in parallel to the CE model; denoising, by the non-AI model, the first portion of the noisy channel data; denoising, by the CE model, remaining portion of the noisy channel data; and combining the denoised first portion and the denoised remaining portion.

At step 2040, the first electronic device may input the preprocessed noisy channel to a CE model trained to perform CE based on the preprocessed noisy channel. The CE model may include residual learning networks (ResNets).

At step 2050, the first electronic device or the CE model may estimate the channel matrix based on denoising of the preprocessed noisy channel.

In one embodiment, the CE model may be trained by: receiving training datasets, each training dataset including a label and a noisy data; preprocessing the noisy data to remove at least one of a timing offset, a multiuser interference, or an intercell interference; inputting the preprocessed noisy data to the CE model; and training the CE model to perform channel estimation based on the preprocessed noisy data and a loss function computed based on the label.

In one embodiment, the CE model may be trained based on training data including a field data collected from a cell site and a simulation data comprising simulated ICIs. In one embodiment, the CE model may be trained based on training data collected from a cell site by a training data collection module configured to collect a label in a high power mode via antennas and collect a noisy data in a low power mode via a subset of the antennas such that the training data is collected from all of coverage areas within the cell site.

In one embodiment, the CE model may be trained based on two-dimensional (2D) convolution. Each ResNet may include 2D convolutional layers. The method 2000 may further include: analyzing inter-kernel correlations and intra-kernel correlations of the 2D convolution; determining that numbers of the inter-kernel correlations and the intra-kernel correlations are higher than respective thresholds; replacing one or more of the 2D convolution layers with a low complexity algorithm based on the determination; and retraining the CE model with the low complexity algorithm. The low complexity algorithm may include a blueprint separable algorithm and a depthwise separable algorithm. The one or more 2D convolution layers may be replaced with the blueprint separable algorithm based on a determination that a number of the intra-kernel correlations is higher than a threshold. The one or more the 2D convolution layers may be replaced with the depthwise separable algorithm based on a determination that a number of the inter-kernel correlations is higher than a threshold.

In one embodiment, retraining of the CE model may be automatically triggered when a prior training of the CE model exhibits a training error. In one embodiment, when the prior training of the CE model is successful, the method 2000 may further include: operating the CE model and a non-AI model in parallel; determining that CE performance of the CE model is higher than CE performance of the non-AI model over a predefined period; terminating the operation of the non-AI model based on the determination; detecting an anomaly in subsequent CE performance of the CE model; and triggering retraining of the AI model based on the detection and recommencing the operation of the non-AI model for CE.

In one embodiment, when the prior training of the CE model is successful, the method 2000 may further include: operating the CE model and a non-AI model in parallel; determining that CE performance of the CE model is not higher than CE performance of the non-AI model over a predefined period; and transmitting a request for additional data of a specified type based on the determination.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims. None of the description in this application should be read as implying that any particular element, step, or function is an essential element that must be included in the claim scope. The scope of patented subject matter is defined only by the claims.

What is claimed is:

1. A method of channel estimation (CE), the method comprising:
receiving, by a first electronic device, a signal from a second electronic device on a channel, the received signal modified by a noise, the channel associated with a channel matrix;
obtaining a noisy channel based on the received signal and a least squares estimate of the channel matrix;
preprocessing the noisy channel to remove at least one of a timing offset (TO), a multiuser interference (MUI), or an intercell interference (ICI);
inputting the preprocessed noisy channel to a CE model trained to perform CE based on the preprocessed noisy channel, the CE model comprising residual learning networks (ResNets); and
estimating the channel matrix based on denoising of the preprocessed noisy channel.

2. The method of claim 1, wherein preprocessing the noisy channel comprises:
transforming the noisy channel from a frequency domain to a delay domain;
removing an MUI from the noisy channel based on a cyclic shift window applied to one or more delay taps preceding and following an interfering peak of the MUI;
retransforming the noisy channel with the MUI removed into the frequency domain;
obtaining a TO estimate from the noisy channel; and
applying a timing compensation to the noisy channel based on the TO estimate, or transforming the noisy channel from a frequency domain into a delay domain;
removing an MUI from the noisy channel based on a cyclic shift window applied to one or more delay taps preceding and following an interfering peak of the MUI;
obtaining a minimum mean square error (MMSE) for the noisy channel based on a power delay profile and a noise power estimate;
identifying a window based on a threshold associated with the noise power estimate, the window comprising noises enhanced based on the MMSE; and
removing the enhanced noises within the window.

3. The method of claim 1, wherein:
preprocessing the noisy channel further comprises determining that noisy channel data includes a first portion having at least one of signal to noise ratio or delay spread greater than a threshold, and
the method further comprises:
inputting the first portion to a non-artificial intelligence (AI) model running in parallel to the CE model;
denoising, by the non-AI model, the first portion of the noisy channel data;
denoising, by the CE model, remaining portion of the noisy channel data; and
combining the denoised first portion and the denoised remaining portion.

4. The method of claim 1, wherein the CE model is trained by:
receiving training datasets, each training dataset including a label and a noisy data;
preprocessing the noisy data to remove at least one of a TO, an MUI, or an ICI;
inputting the preprocessed noisy data to the CE model; and
training the CE model to perform channel estimation based on the preprocessed noisy data and a loss function computed based on the label.

5. The method of claim 1, wherein:
the CE model is trained based on training data including a field data collected from a cell site and a simulation data comprising simulated ICIs, or
the CE model is trained based on training data collected from a cell site by a training data collection module configured to collect a label in a high power mode via antennas and collect a noisy data in a low power mode via a subset of the antennas such that the training data is collected from all of coverage areas within the cell site.

6. The method of claim 1, wherein:
the CE model is trained based on two-dimensional (2D) convolution, each ResNet including 2D convolution layers,
the method further comprises:
analyzing inter-kernel correlations and intra-kernel correlations of the 2D convolution;
determining that numbers of the inter-kernel correlations and the intra-kernel correlations are higher than respective thresholds;
replacing one or more of the 2D convolution layers with a low complexity algorithm based on the determination; and
retraining the CE model with the low complexity algorithm, and
the low complexity algorithm comprises a blueprint separable algorithm and a depthwise separable algorithm, and wherein the one or more 2D convolution layers are replaced with the blueprint separable algorithm based on a determination that a number of the intra-kernel correlations is higher than a threshold, and wherein the one or more the 2D convolution layers are replaced with the depthwise separable algorithm based on a determination that a number of the inter-kernel correlations is higher than a threshold.

7. The method of claim 1, wherein:
retraining of the CE model is automatically triggered when a prior training of the CE model exhibits a training error, or
when the prior training of the CE model is successful, the method further comprises:
operating the CE model and a non-artificial intelligence (AI) model in parallel;
determining that CE performance of the CE model is higher than CE performance of the non-AI model over a predefined period;
terminating the operation of the non-AI model based on the determination;
detecting an anomaly in subsequent CE performance of the CE model; and
triggering retraining of the AI model based on the detection and recommencing the operation of the non-AI model for CE, or
operating the CE model and a non-artificial intelligence (AI) model in parallel;
determining that CE performance of the CE model is not higher than CE performance of the non-AI model over a predefined period; and
transmitting a request for additional data of a specified type based on the determination.

8. A first electronic device comprising:
memory; and
a processor operably coupled to the memory, the processor configured to:
receive a signal from a second electronic device on a channel, the received signal modified by a noise, the channel associated with a channel matrix;
obtain a noisy channel based on the received signal and a least squares estimate of the channel matrix;
preprocess the noisy channel to remove at least one of a timing offset (TO), a multiuser interference (MUI), or an intercell interference (ICI);
input the preprocessed noisy channel to a CE model trained to perform CE based on the preprocessed noisy channel, the CE model comprising residual learning networks (ResNets); and
estimate the channel matrix based on denoising of the preprocessed noisy channel.

9. The first electronic device of claim 8, wherein to preprocess the noisy channel, the processor is further configured to:
transform the noisy channel from a frequency domain to a delay domain;
remove an MUI from the noisy channel based on a cyclic shift window applied to one or more delay taps preceding and following an interfering peak of the MUI;
retransform the noisy channel with the MUI removed into the frequency domain;
obtain a TO estimate from the noisy channel; and
apply a timing compensation to the noisy channel based on the TO estimate, or transform the noisy channel from a frequency domain into a delay domain;
remove an MUI from the noisy channel based on a cyclic shift window applied to one or more delay taps preceding and following an interfering peak of the MUI;
obtain minimum mean square error (MMSE) weights for the noisy channel based on a power delay profile and a noise power estimate;
identify a window based on a threshold associated with the noise power estimate and the MMSE weights, the window comprising noises enhanced based on the MMSE weights; and
remove the enhanced noises within the window.

10. The first electronic device of claim 8, wherein to preprocess the noisy channel, the processor is further configured to:
determine that noisy channel data includes a first portion having at least one of signal to noise ratio or delay spread greater than a threshold;
input the first portion to a non-artificial intelligence (AI) model running in parallel to the CE model;
denoise, by the non-AI model, the first portion of the noisy channel data;
denoise, by the CE model, remaining portion of the noisy channel data; and
combine the denoised first portion and the denoised remaining portion.

11. The first electronic device of claim 8, wherein:
the processor is further configured to train the CE model, and
to train the CE model, the processor is further configured to:
receive training datasets, each training dataset including a label and a noisy data;
preprocess the noisy data to remove at least one of a TO, an MUI, or an ICI;
input the preprocessed noisy data to the CE model; and
train the CE model to perform channel estimation based on the preprocessed noisy data and a loss function computed based on the label.

12. The first electronic device of claim 8, wherein:
the CE model is trained based on training data including a field data collected from a cell site and a simulation data comprising simulated ICIs, or
the CE model is trained based on training data collected from a cell site by a training data collection module configured to collect a label in a high power mode via antennas and collect a noisy data in a low power mode via a subset of the antennas such that the training data is collected from all of coverage areas within the cell site.

13. The first electronic device of claim 8, wherein:
the CE model is trained based on two-dimensional (2D) convolution, each ResNet including 2D convolution layers,
the processor is further configured to:
analyze inter-kernel correlations and intra-kernel correlations of the 2D convolution;
determine that numbers of the inter-kernel correlations and the intra-kernel correlations are higher than respective thresholds;
replace one or more of the 2D convolution layers with a low complexity algorithm based on the determination; and
retrain the CE model with the low complexity algorithm, and
the low complexity algorithm comprises a blueprint separable algorithm and a depthwise separable algorithm, and wherein the one or more 2D convolution layers are replaced with the blueprint separable algorithm based on a determination that a number of the intra-kernel correlations is higher than a threshold, and wherein the one or more the 2D convolution layers are replaced with the depthwise separable algorithm based on a determination that a number of the inter-kernel correlations is higher than a threshold.

14. The first electronic device of claim 8, wherein:
when a prior training of the CE model exhibits a training error, the processor is further configured to automatically trigger retraining of the CE model, or
when the prior training of the CE model is successful, the processor is further configured to:
operate the CE model and a non-artificial intelligence (AI) model in parallel;
determine that CE performance of the CE model is higher than CE performance of the non-AI model over a predefined period;
terminate the operation of the non-AI model based on the determination;
detect an anomaly in subsequent CE performance of the CE model; and
trigger retraining of the AI model based on the detection and recommencing the operation of the non-AI model for CE, or
operate the CE model and a non-artificial intelligence (AI) model in parallel;
determine that CE performance of the CE model is not higher than CE performance of the non-AI model over a predefined period; and
transmit a request for additional data of a specified type based on the determination.

15. A non-transitory computer readable medium embodying a computer program, the computer program comprising program code that, when executed by a processor of a first electronic device, causes the first electronic device to:
receive a signal from a second electronic device on a channel, the received signal modified by a noise, the channel associated with a channel matrix;
obtain a noisy channel based on the received signal and a least squares estimate of the channel matrix;
preprocess the noisy channel to remove at least one of a timing offset (TO), a multiuser interference (MUI), or an intercell interference (ICI);
input the preprocessed noisy channel to a CE model trained to perform CE based on the preprocessed noisy channel, the CE model comprising residual learning networks (ResNets); and
estimate the channel matrix based on denoising of the preprocessed noisy channel.

16. The non-transitory computer readable medium of claim 15, wherein the program code that, when executed by the processor of the first electronic device, causes the first electronic device to preprocess the noisy channel comprises program code that, when executed by the processor of the first electronic device, causes the first electronic device to:
transform the noisy channel from a frequency domain to a delay domain;
remove an MUI from the noisy channel based on a cyclic shift window applied to one or more delay taps preceding and following an interfering peak of the MUI;
retransform the noisy channel with the MUI removed into the frequency domain;
obtain a TO estimate from the noisy channel; and
apply a timing compensation to the noisy channel based on the TO estimate, or
transform the noisy channel from a frequency domain into a delay domain;
remove an MUI from the noisy channel based on a cyclic shift window applied to one or more delay taps preceding and following an interfering peak of the MUI;
obtain minimum mean square error (MMSE) weights for the noisy channel based on a power delay profile and a noise power estimate;
identify a window based on a threshold associated with the noise power estimate and the MMSE weights, the window comprising noises enhanced based on the MMSE weights; and
remove the enhanced noises within the window.

17. The non-transitory computer readable medium of claim 15, wherein the program code that, when executed by the processor of the first electronic device, causes the first electronic device to preprocess the noisy channel comprises program code that, when executed by the processor of the first electronic device, causes the first electronic device to:
determine that noisy channel data includes a first portion having at least one of signal to noise ratio or delay spread greater than a threshold;
input the first portion to a non-artificial intelligence (AI) model running in parallel to the CE model;
denoise, by the non-AI model, the first portion of the noisy channel data;
denoise, by the CE model, remaining portion of the noisy channel data; and
combine the denoised first portion and the denoised remaining portion.

18. The non-transitory computer readable medium of claim 15, wherein:
the computer program further comprises program code that, when executed by a processor of the first electronic device, causes the first electronic device to train the CE model, and
the program code that, when executed by the processor of the electronic device, causes the first electronic device to train the CE model comprises program code that, when executed by the processor of the first electronic device, causes the first electronic device to:
receive training datasets, each training dataset including a label and a noisy data;
preprocess the noisy data to remove at least one of a TO, an MUI, or an ICI;
input the preprocessed noisy data to the CE model; and
train the CE model to perform channel estimation based on the preprocessed noisy data and a loss function computed based on the label.

19. The non-transitory computer readable medium of claim 15, wherein:
the CE model is trained based on training data including a field data collected from a cell site and a simulation data comprising simulated ICIs, or
the CE model is trained based on training data collected from a cell site by a training data collection module configured to collect a label in a high power mode via antennas and collect a noisy data in a low power mode via a subset of the antennas such that the training data is collected from all of coverage areas within the cell site.

20. The non-transitory computer readable medium of claim 15, wherein:
the CE model is trained based on two-dimensional (2D) convolution, each ResNet including 2D convolution layers,
the computer program further comprises program code that, when executed by a processor of the first electronic device, causes the first electronic device to:
analyze inter-kernel correlations and intra-kernel correlations of the 2D convolution;
determine that numbers of the inter-kernel correlations and the intra-kernel correlations are higher than respective thresholds;
replace one or more of the 2D convolution layers with a low complexity algorithm based on the determination; and
retrain the CE model with the low complexity algorithm, and
the low complexity algorithm comprises a blueprint separable algorithm and a depthwise separable algorithm, and wherein the one or more 2D convolution layers are replaced with the blueprint separable algorithm based on a determination that a number of the intra-kernel correlations is higher than a threshold, and wherein the one or more the 2D convolution layers are replaced with the depthwise separable algorithm based on a determination that a number of the inter-kernel correlations is higher than a threshold.
